(19) United States
(12) Patent Application Publication
(10) Pub. No.: US 2005/0246689 A1
(43) Pub. Date: Nov. 3, 2005

(54) Symbol table discarding

(76) Inventors: Venkatesh Radhakrishnan, Cupertino, CA (US); Poorva Gupta, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/837,463

(22) Filed: Apr. 29, 2004

(51) Int. Cl. G06F 9/44

(52) U.S. Cl. 717/124

(57) ABSTRACT

A method of debugging a software program is disclosed. The method includes ascertaining one of a minimal symbol and a partial symbol associated with a first symbol required for the debugging. The method further includes ascertaining a partial symbol table associated with the one of the minimal symbol and the partial symbol. The method additional includes updating, if there exists a symbol table corresponding to the partial symbol table, a usage indicator associated with the symbol table and employing the symbol table to provide the first symbol for the debugging. The usage indicator indicates a usage level of the symbol table relative to other symbol tables in the computer system.

### BACKGROUND OF THE INVENTION

Debuggers have long been employed to assist in the creation and/or maintenance of software. To facilitate discussion, FIG. 1 is a prior art illustration showing some of the data structures involved in a typical debugging session. As is typical with many modern software programs, the target program (i.e., the program to be debugged) may contain many source files (not shown in FIG. 1).

Upon startup, the debugger 104 obtains the list of object files (102a, 102b, and 102c) from the dynamic linker (not shown) and creates object data structures called objfiles (106, 108, and 110). In this disclosure, the debugger gdb, available from the Hewlett-Packard Company of Palo Alto, Calif. is employed to facilitate discussion although other suitable debuggers may well be employed. There is generally an instance of the objfile data structure for each object file (whether an executable or a shared library). These instances of objfile (objfiles) are typically stored in a linked list. For each objfile (106, 108, or 110), the debugger also reads in the linker symbol table from disk and creates the minimal symbol table data structure, which contains the minimal symbols (minsyms). With reference to FIG. 1, minimal symbol table 112 corresponding to object data structure objfile 106 is shown. Minimal symbol table 112 includes a plurality of minimal symbol minsyms 114, 116 and 118.

FIG. 2 shows additional data structures involved in the debugger. After the minimal symbols are created for the obj files, the debugger performs a top-level scan of the debug information on disk and creates, for each compilation unit, a partial symbol table (psymtab). As is well known, each source file may correspond to one or more compilation units. These partial symbol tables psymtabs 202, 204, and 206 are associated with obj file 106 in FIG. 2, and are linked together via a linked list. If there is a partial symbol in that compilation unit that does not have a corresponding minimal symbol, the debugger also adds that partial symbol to the minimal symbol table (112) associated with that compilation unit. Thus, there is a minimal symbol table (e.g., 112) and a plurality of partial symbol tables (e.g., psymtabs 202, 204, and 206) for each objfile (e.g., 106).

FIG. 2 further shows that each minimal symbol table (112) also has pointers pointing to its minimal symbols and partial symbols. For example, a plurality of pointers 212, 214, 216, 218, and 220 point to minimal symbols 114, 116, and 118 and partial symbols 240 and 242. The minimal symbols 114, 116, and 118 and partial symbols 240 and 242 also have pointers (250, 252, 254, 256, and 258) pointing to their partial symbol table psymtabs 202, 204, and 206. The various partial symbol tables (e.g., psymtabs 202, 204, and 206) are linked via a linked list, the pointer to which is held by the corresponding obj file (pointer 270 from objfile 206 to psymtab 202)

FIG. 2 also shows a symbol table symtab 260. A symbol table (symtab) contains the complete debug information (including types and symbols) for the compilation unit and is typically much larger than the partial symbol table. During debugging, symbol tables (symtabs) are created as needed. If a symbol is needed during debugging, the debugger first accesses the minimum symbol table (112) from the objfile (106) by following pointer 266. From the minimum symbol table (112), the debugger accesses its minimal symbol (e.g., 114, 116, or 118) or partial symbol (240 or 242). Once the required minimal symbol or partial symbol is found, the debugger follows one of pointers 250, 252, 254, 256, or 258 to access the requisite partial symbol table (e.g., psymtab 202, 204, or 206).

If there is a corresponding symbol table for the accessed partial symbol table (e.g., symtab 260 for psymtab 202), the required symbol is obtained from the existing symbol table (e.g., symtab 260) for use in debugging. On the other hand, if there is no existing symbol table for the accessed partial symbol table (e.g., in the case of psymtab 206 wherein the pointer is null), the debugger would expand (i.e., create) the required symbol table syrntab by reading the debug information, which is found on disk using information stored in the accessed partial symbol table (e.g., psymtab 206). Note that all the created symbol tables are linked together via a linked list, the pointer to which is held by the corresponding objfile (e.g., pointer 272 from objfile 106 to symtab 260).

As can be appreciated from the foregoing, symbol tables are created as needed. In some cases, the number of symbol tables (symtabs) required during a debug session may grow quite large, requiring a huge amount of memory for storing their symbols and types as the debugging session proceeds. If the amount of available memory is exhausted, it may not be possible to expand additional symbol tables (symtabs) when a symbol is required. When this happens, the debugger crashes.

### SUMMARY OF INVENTION

The invention relates, in an embodiment, to a method of debugging a software program. The method includes ascertaining one of a minimal symbol and a partial symbol associated with a first symbol required for the debugging. The method further includes ascertaining a partial symbol table associated with the one of the minimal symbol and the partial symbol. The method additionally includes updating, if there exists a symbol table corresponding to the partial symbol table, a usage indicator associated with the symbol table and employing the symbol table to provide the first symbol for the debugging. The usage indicator indicates a usage level of the symbol table relative to other symbol tables in the computer system.

In another embodiment, the invention relates to an arrangement for debugging software. The arrangement includes an object file and a plurality of partial symbol tables associated with the object file. The arrangement further includes a plurality of first obstacks for allocating memory for symbol tables expanded from the plurality of partial symbol tables, each of the plurality of first obstacks being associated with a respective one of the plurality of partial symbol tables.

In yet another embodiment, the invention relates to a method of debugging a software program. The method includes ascertaining a memory usage level. The method includes de-allocating memory, if the memory usage level exceeds a first memory usage threshold. The de-allocating memory includes ascertaining at least a first symbol table, and discarding a symbol obstack associated with the first symbol table, wherein the symbol obstack is employed for storing symbol names associated with only the first symbol table.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a prior art illustration showing some of the data structures involved in a typical debugging session.

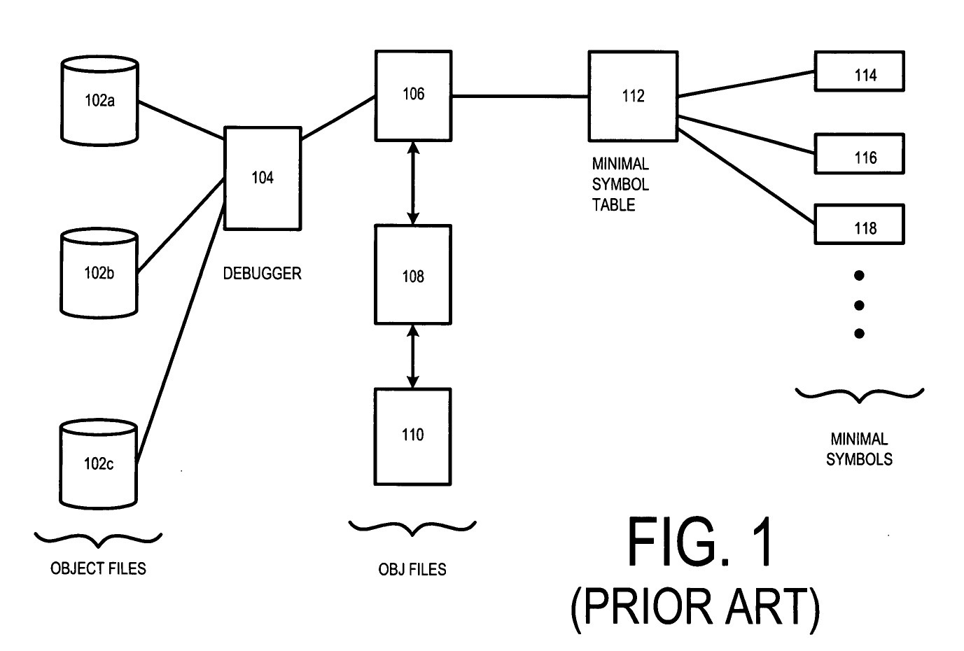

FIG. 2 is a prior art illustration showing additional data structures involved in the debugging process.

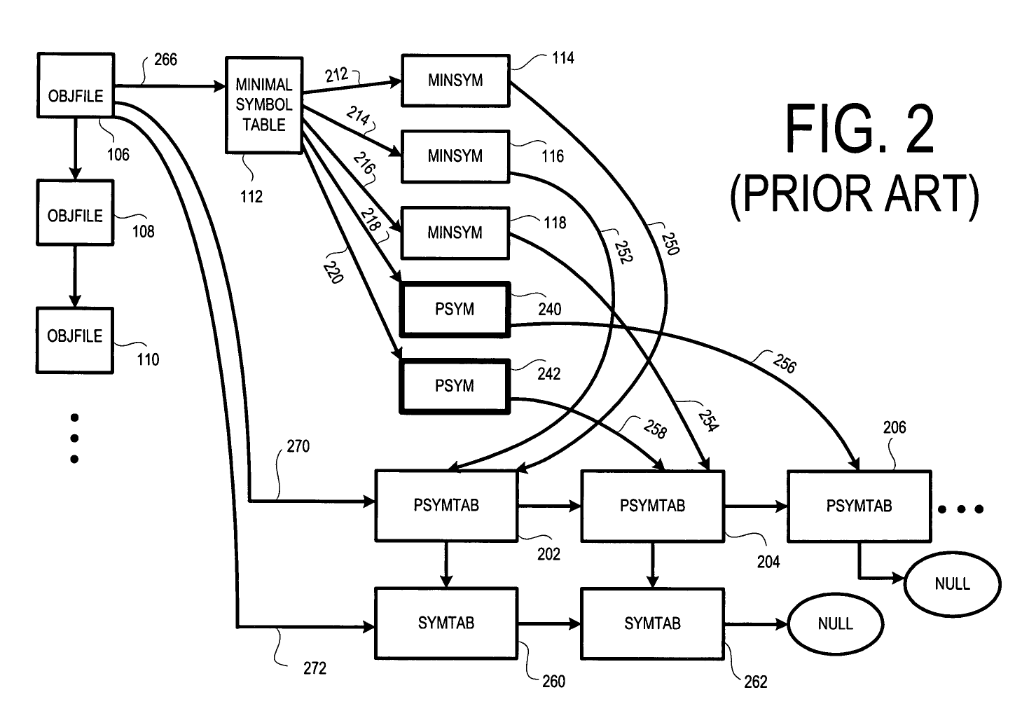

FIG. 3 illustrates a prior art memory allocation scheme.

FIG. 4 shows, in accordance with an embodiment of the present invention, the improved memory allocation scheme.

FIG. 5 shows, in accordance with an embodiment of the present invention, the steps taken when a symbol is required for debugging.

### DETAILED DESCRIPTION OF VARIOUS EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with embodiments of the present invention, there are provided arrangements for monitoring symbol table usage and for enabling the efficient discarding of infrequently used symbol tables in order to de-allocate memory when needed. The de-allocated memory is then available to accommodate future symbol table expansion. Furthermore, embodiments of the present invention include methods for monitoring memory usage by the symbol tables, for timely discarding a sufficient number of symbol tables so that there is sufficient de-allocated memory to accommodate any required symbol table expansion.

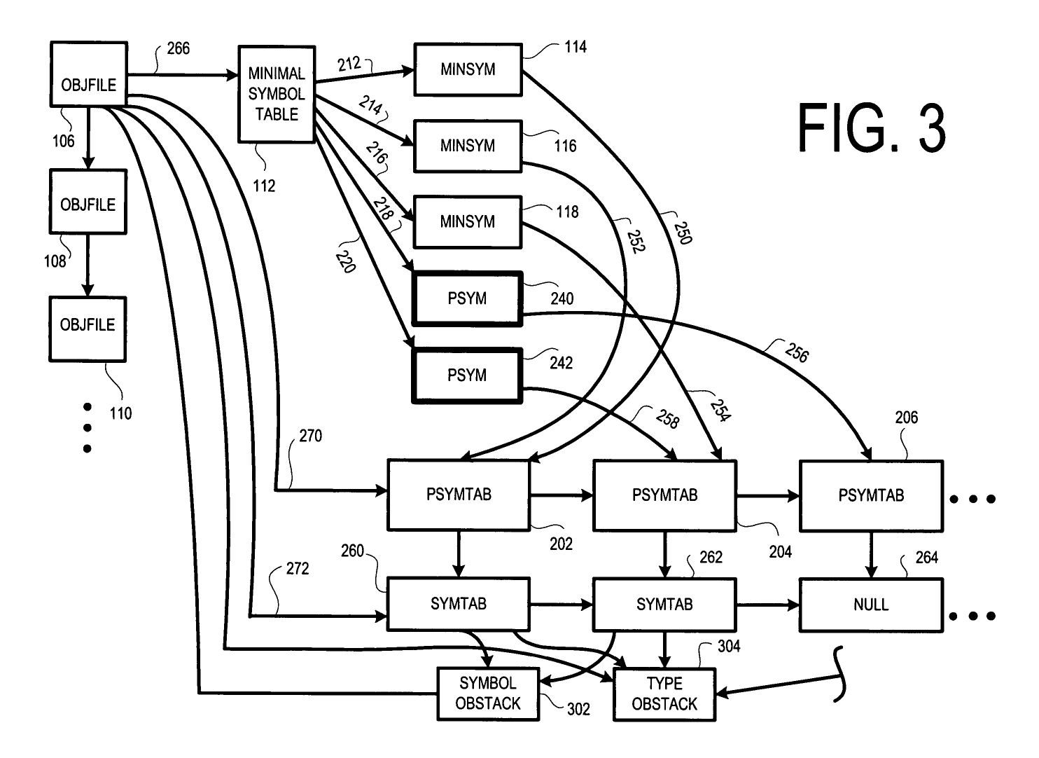

To facilitate discussion, consider the memory allocation scheme in the prior art, which is represented in FIG. 3. As mentioned, a symbol table includes types and symbols required for debugging. As symbol tables are expanded, memory needs to be allocated to accommodate the newly expanded symbol table(s). In the prior art, the memory required for the various types are allocated in a type obstack, and the memory required for the various symbols are allocated in a symbol obstack. Generally speaking, a type obstack stores data types, and a symbol obstack stores symbols, such as names of variables or functions, among other things. As is well-known, an obstack is a data structure employed for rapid allocation and de-allocation of memory.

In the prior art, there is only one type obstack and only one symbol obstack per objfile. Accordingly, memory for storing symbols associated with symbol tables 260 and 262 are allocated in symbol obstack 302, while memory for storing types associated with symbol tables 260 and 262 are allocated in type obstack 304.

Even if symbol table discarding were contemplated in the prior art, since the symbols and types associated with all symbol tables (e.g., both symtabs 260 and 262) are stored in the same symbol obstack (302) and the same type obstack (304) in accordance with the prior art memory allocation scheme, it is recognized by the inventor that it would have been difficult to efficiently discard types and symbols associated with any specific symbol table without impacting another symbol table. For example, it would have been difficult to discard only symbols and types associated with symtab 260 without impacting the symbols and types associated with symtab 262. In fact, it is exceedingly difficult, if not impossible, to de-allocate only a part of an obstack, whether a type obstack or a symbol obstack. Accordingly, memory cannot be efficiently de-allocated in the prior art in order to accommodate future symbol table expansion.

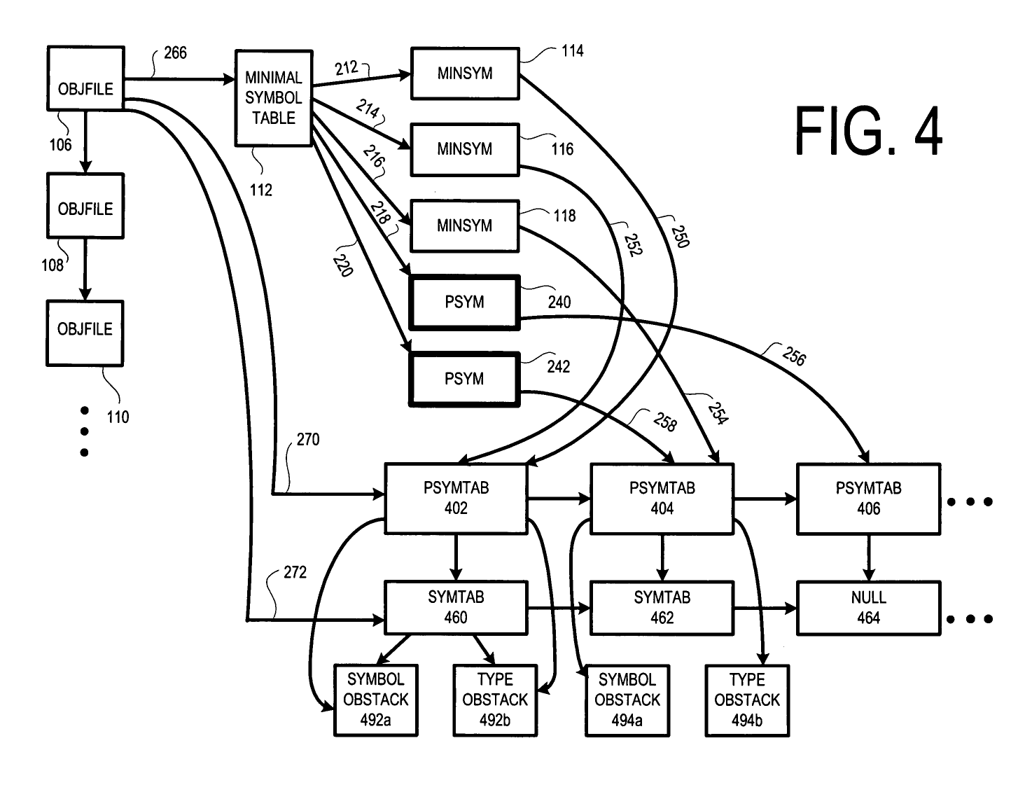

FIG. 4 shows, in accordance with an embodiment of the present invention, the improved memory allocation scheme. In order to enable the efficient de-allocation of memory at the symbol table (symtab) level, there are provided multiple symbol obstacks and multiple type obstacks for each obj file. More specifically, there is associated with each partial symbol table (psymtab) a symbol obstack and a type obstack.

Thus, with reference to FIG. 4, there is a symbol obstack 492a associated with partial symbol table psymtab 402. There is a type obstack 492b associated with partial symbol table psymtab 402. Furthermore, there is a symbol obstack 494a associated with partial symbol table psymtab 404. Additionally, there is a type obstack 494b associated with partial symbol table psymtab 404. Note that the handle to (e.g., pointer to) a symbol obstack is held by the psymtab instead of by the symbol table even though one of the purposes of the improved memory allocation scheme is the efficient de-allocation of memory when a symbol table is discarded. In other words, the pointers to the type obstack and the symbol obstack originate from the partial symbol table instead of from the symbol table. This takes into account situations where the symbol table may not have been expanded yet.

When a symbol table (e.g., symtab 462) is created, the pointers to its symbol obstack (e.g., 494a) and the type obstack (e.g., 494b) associated with that newly created symbol table symtab 462 is set to be equal to the pointers from the partial symbol table psymtab 404 (which is associated with symbol table 462) to the symbol obstack 494a and the type obstack 494b. If memory needs to be de-allocated, a symbol table may be readily discarded by discarding the entire symbol obstack and the entire type obstack associated with that symbol table. In an embodiment, the symbol table (symtab) is conceptual. That is, the handles (e.g., the pointers) to the type obstack and the symbol obstack of the symbol table are held by the psymtab. Once the type obstack and the symbol obstack are discarded, the symbol table is effectively discarded. In another embodiment, the memory allocated to the symbol table, if any, may be deallocated once the type obstack and symbol obstack are discarded.

During debugging, memory usage is monitored. In accordance with embodiments of the present invention, there is provided a symtab discard threshold, which may be user-selectable or may be predefined. When memory usage exceeds the symtab discard threshold, one or more symtabs (such as 460 or 462) (including their type and symbol obstacks) are discarded. The number of symtabs to be discarded depends on the strategy selected. In an embodiment, a sufficient number of symtabs is discarded so that the memory usage level falls below a safe-harbor threshold, which again may be user-selectable or pre-defined. The safe-harbor threshold value may also be determined at run time depending on the projected size of the symbol table to be expanded so as to minimize the number of symbol tables that need to be discarded. In term of memory utilization, the safe-harbor threshold is different from and lower than the symtab discard threshold. For example, the symtab discard threshold may be 75% (in term of usage of available memory) and the safe-harbor threshold may be 60% (in term of usage of available memory). In this case, when memory usage exceeds 75%, a sufficient number of symtabs (including their type and symbol obstacks) is discarded so that memory usage falls below the 60% threshold of the safe-harbor value.

Generally speaking, the least recently used symbol table(s) are selected for discard if symtab discarding is necessary. This is because a symbol table (symtab) that has not been utilized recently is unlikely to be needed in the near future for debugging purposes. There are many strategies for marking and/or ascertaining the least recently used symtabs, all of which may be employed. In an embodiment, the symtabs are modified to include a time stamp field. Accesses to the symtabs are modified such that every time a symbol table (symtab) is accessed, its time stamp field is updated. When the time comes to decide which symtab(s) to discard, the time stamp values of the symtabs are examined to ascertain which symtab or symtabs should be discarded. In accordance with embodiments of the invention, the time stamps themselves may be actual times or may represent counter values.

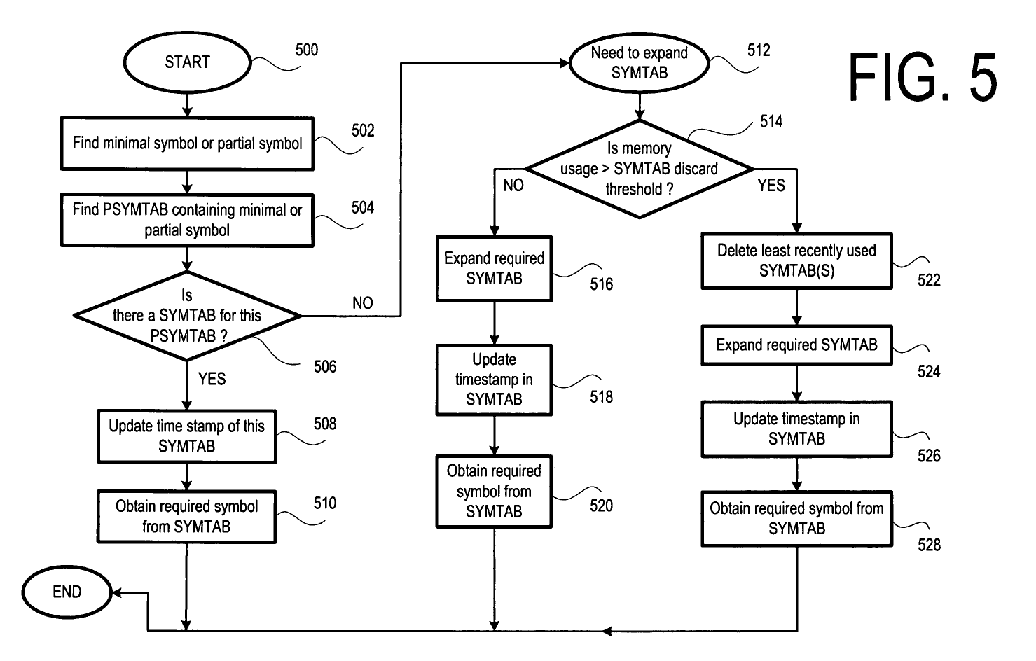

FIG. 5 shows, in accordance with an embodiment of the present invention, the steps taken when a symbol is required for debugging. In step 502, the minimal symbol or partial symbol corresponding to the required symbol is found. The minimal symbols and the partial symbols are shown in FIG. 4 as, for example, minsym 118 or psym 242. In step 504, the partial symbol table (psymtab) corresponding to the minsym or psym found in step 502 is ascertained. With reference to FIG. 4, this partial symbol table may be, for example, psymtab 404.

In step 506, it is ascertained whether there exists a symbol table (symtab) for the partial symbol table (psymtab) found in step 504. If there is a symbol table already expanded for the psymtab (e.g., symbol table 462 for psymtab 404 in FIG. 4), the method proceeds to step 508, wherein the timestamp value for this symbol table is updated to indicate its utilization. In this manner, the usage level of this symbol table may be gauged relative to the usage level of other symbol tables. For example, a symbol table with a recently updated time stamp may be considered to have a higher usage level (due to its being recently used) than a symbol table that has not had its time stamp updated for a long time. In step 510, the required symbol is obtained from the symbol table found in step 508.

On the other hand, if it is determined in step 506 that there is no existing symbol table (symtab) for the partial symbol table (psymtab) found in step 504, symbol table expansion needs to be performed. This is indicated in FIG. 5 by state 512. In this state, the method proceeds to step 514 to ascertain whether the memory utilization is such that additional memory needs to be de-allocated before symbol table expansion can take place. As an example, the symbol table (symtab) discard threshold may be set at 75%. If the memory utilization is below this 75% symtab discard threshold level, the method proceeds to step 516 in order to expand the symbol table. This 75% symtab discard threshold setting is based on the assumption in this example that symbol table expansion can take place in the 25% of memory space remaining.

As part of the symbol table expansion, the debug information from disk is read using information from the partial symbol table. Once the symbol table is expanded, the method proceeds to step 518, wherein the timestamp value for this symbol table is updated to indicate that it is utilized. In step 520, the required symbol is obtained from the symbol table expanded in step 516.

On the other hand, if it is determined in step 514 that the memory utilization is above this 75% symtab discard threshold level, the method proceeds to step 522 in order to discard selected symbol table(s) until the memory utilization is at an acceptable level. The borderline case, e.g., memory utilization level equals the symtab discard threshold level may be handled as either requiring discard or not requiring discard as desired. As mentioned, embodiments of the invention discard least recently used symbol table(s) until a safe-harbor memory utilization level is reached. Once memory is sufficiently de-allocated for symbol table expansion, the method proceeds to step 524 in order to expand the symbol table. As part of the symbol table expansion, the debug information from disk is read using information from the partial symbol table. Once the symbol table is expanded, the method proceeds to step 526, wherein the timestamp value for this symbol table is updated to indicate that it is utilized. In step 528, the required symbol is obtained from the symbol table expanded in step 524.

As can be appreciated from the foregoing, embodiments of the invention ensures that debugging of large, complex programs can take place even if there is a limited amount of resources, such as memory, available for symbol table expansion. By arranging the memory allocation scheme such that symbol tables can be discarded efficiently (by discarding entire symbol obstacks and type obstacks on a symtab-by-symtab basis), there is minimal impact on performance. Further, by discarding only the least frequently used symbol tables, impact on performance is further minimized.

While this invention has been described in terms of several embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. In a computer system, a method for facilitating symbol table discarding while debugging a software program, comprising:
ascertaining one of a minimal symbol and a partial symbol associated with a first symbol required for said debugging;
ascertaining a partial symbol table associated with said one of said minimal symbol and said partial symbol; and
if there exists a symbol table corresponding to said partial symbol table, updating a usage indicator associated with said symbol table and employing said symbol table to provide said first symbol for said debugging, said usage indicator indicating a usage level of said symbol table relative to other symbol tables in said computer system.

2. The method of claim 1 further comprising:
ascertaining, if there is no symbol table corresponding to said partial symbol table, a memory usage level;
if said memory usage level exceeds a first memory usage threshold, de-allocating memory by:
a) ascertaining at least a first least-recently-used symbol table among symbol tables existing in said computer system; and
b) discarding a first symbol obstack associated with said first least-recently-used symbol table, wherein said first symbol obstack is associated with no more than one partial symbol table.

3. The method of claim 2 further comprising discarding a type obstack associated with said least-recently-used symbol table, wherein said symbol obstack is associated with no more than one partial symbol table.

4. The method of claim 2 further comprising discarding a sufficient number of symbol obstacks in said computer system until a second memory usage threshold is reached, said second memory usage threshold being lower than said first memory usage threshold.

5. The method of claim 2 wherein said first least-recently-used symbol table is ascertained by comparing a usage indicator associated with said first least-recently-used symbol table with other usage indicators associated with other symbol tables in said computer system.

6. The method of claim 5 wherein said usage indicator is one of a time stamp and a counter.

7. An arrangement for debugging software, comprising:
an object file;
a plurality of partial symbol tables associated with said object file; and
a plurality of first obstacks for allocating memory for symbol tables expanded from said plurality of partial symbol tables, each of said plurality of first obstacks being associated with a respective one of said plurality of partial symbol tables.

8. The arrangement of claim 7 wherein said plurality of first obstacks represent a plurality of symbol obstacks.

9. The arrangement of claim 7 wherein said plurality of first obstacks represent a plurality of type obstacks.

10. The arrangement of claim 7 further comprising a plurality of type obstacks for allocating memory for type names of said symbol tables, each of said plurality of type obstacks being associated with said respective one of said plurality of partial symbol tables, wherein said plurality of first obstacks represent a plurality of symbol obstacks for allocating memory for symbol names of said symbol tables.

11. In a computer system, a method of debugging a software program, comprising:
ascertaining a memory usage level; and
if said memory usage level exceeds a first memory usage threshold, de-allocating memory by
ascertaining at least a first symbol table, and
discarding a symbol obstack associated with said first symbol table, wherein said symbol obstack is employed for storing symbol names associated with only said first symbol table.

12. The method of claim 11 wherein said first symbol table represents a first least-recently-used symbol table.

13. The method of claim 11 further comprising
providing a plurality of symbol obstacks, each of said plurality of symbol obstacks being associated with one respective symbol table in said computer system.

14. The method of claim 13 further comprising discarding, in addition to said first symbol obstack, a sufficient number of symbol obstacks associated with symbol tables in said computer system until a second memory usage threshold is reached, said second memory usage threshold being lower than said first memory usage threshold.

15. The method of claim 13 further comprising
expanding, if said memory usage level is below said first memory usage threshold, a symbol table from its partial symbol table and marking said symbol table with a usage indicator to indicate a time of its usage relative to usage times of other symbol tables.

16. The method of claim 15 wherein said usage indicator is one of a time stamp and a counter.

17. The method of claim 11 wherein said first symbol table represents a least-recently used symbol table, said first symbol table being ascertained by comparing a usage indicator associated with said first symbol table with other usage indicators associated with other symbol tables in said computer system.

18. The method of claim 17 wherein said usage indicator is one of a time stamp and a counter.

19. The method of claim 11 wherein said de-allocating further includes
discarding a type obstack associated with said first symbol table, wherein said type obstack is employed for storing type names associated with only said first symbol table.
